(19) United States
(12) Patent Application Publication
(10) Pub. No.: US 2025/0193948 A1
(43) Pub. Date: Jun. 12, 2025

(54) D2D BASED RELAYING OF CONTROL DATA

(71) Applicant: Telefonaktiebolaget LM Ericsson (publ), Stockholm (SE)

(72) Inventors: Majid GERAMI, LUND (SE); Bikramjit SINGH, RAASEPORI (FI); Min WANG, LULEÅ (SE)

(73) Assignee: Telefonaktiebolaget LM Ericsson (publ), Stockholm (SE)

(21) Appl. No.: 18/846,254

(22) PCT Filed: Mar. 31, 2022
(86) PCT No.: PCT/EP2022/058590

§ 371 Date: Sep. 12, 2024

(51) Int. Cl. H04W 76/14; H04W 72/21; H04W 88/04

(52) U.S. Cl. CPC H04W 76/14; H04W 72/21; H04W 88/04

(57) ABSTRACT

A wireless device receives a first device-to-device communication message from a first other wireless device and a second first device-to-device communication message from a second other wireless device. From the first device-to-device communication message, the wireless device decodes first uplink control data from the first other wireless device. From the second device-to-device communication message, the wireless device decodes second uplink control data from the second other wireless device. Further, the wireless device sends an uplink message comprising the first uplink control data and the second uplink control data to a node of the wireless communication network.

### CROSS-REFERENCE TO RELATED APPLICATIONS

This patent application is a submission under 35 U.S.C. § 371 for U.S. national stage patent application of international application no. PCT/EP2022/058590 filed on Mar. 31, 2022 and entitled “D2D BASED RELAYING OF CONTROL DATA,” the entirety of which is incorporated herein by reference.

### TECHNICAL FIELD

The present invention relates to methods for controlling wireless transmissions and to corresponding devices, systems, and computer programs.

### BACKGROUND

In wireless communication networks, e.g., based on the 4G (4^{th} Generation) LTE (Long Term Evolution) or 5G (5^{th} Generation) NR technology as specified by 3GPP (3^{rd} Generation Partnership Project), it is known to support device-to-device (D2D) communication between wireless devices, typically referred to as “user equipment” (UE). Such D2D communication is supported in addition to downlink (DL) communication from the wireless communication network to the UE and uplink (UL) communication from the UE to the wireless communication network. The D2D communication is also denoted as sidelink (SL) communication.

One use case of SL communication is UE-to-Network relay. For example, sections 6.6 and 6.7 of 3GPP TR 23.752 V17.0.0 (2021-03) describe L2 (Layer 2) and Layer 3 (L3) UE-to-Network relay. In “Special Articles on LTE-Advanced Technology—Ongoing Evolution of LTE toward IMT-Advanced—Relay Technology in LTE-Advanced” by M. Iwamura et al., NTT DOCOMO Technical Journal Vol. 12 No. 2, also includes a discussion of L1 (Layer 1) UE-to-Network relaying.

With either L2 and L3 SL relaying operation, a remote UE which is out of network coverage can connect to the network via a relay UE so that the remote UE can transmit or receive data to or from the network via the relay UE. As soon as data is transmitted from the remote UE to the relay UE, this data is further relayed by the relay UE to the network, using a connection of the relay UE to the network. These relayed data transmitted by the relay UE are treated similarly as local data which are generated by the relay UE itself and transmitted to the network. Transmission of the relayed data may involve that the relay UE transmits L1/L2 control signaling to the network, such as PUCCH (Physical UL Control Channel) signaling), and receives L1/L2 control signaling from the network, such as PDCCH (Physical DL Control Channel) signaling. However, the existing mechanisms do not support L1/L2 control signaling between the remote UE and the network. This may for example have the effect that for SL transmissions by the remote UE, it is not possible to benefit from dynamic scheduling of SL resources by the network. As a result, the remote UE may need to transmit using semi-statically configured SL grants or resources autonomously selected by the remote UE. This may limit the SL resource utilization efficiency, since other remote UEs may use the same resources, with the risk of collision and interference between UEs. Similar problems not only exist for signaling to request indicate dynamic SL grants, but also for other control signaling, such as a HO (Handover) command from the network to the remote UE.

3GPP contribution “Sidelink resource allocation and configuration for bi-directional UE-to-NW relaying”, document R1-1713030, 3GPP TSG RAN WG1 Meeting #90, Prague, Czech Republic (May 2017), describes L1/L2 SL relaying, focusing on how to deliver an SL grant to a remote UE. In particular, it is proposed that a relay UE forwards the SL grant to the remote UE, using a MAC-CE (Medium Access Control Control Element). The remote UE can request an SL grant from an eNB via the relay UE, by transmitting a BSR (Buffer Status Report) on SL resources granted during connection setup or by first transmitting a SR (Scheduling Request) for SL resources. However, in this case the signaling between the remote UE and the network is limited to SL grants, SRs, and BSRs. Further, utilization of resources may become inefficient if there multiple remote UEs use the same relay UE for connecting to the network.

Accordingly, there is a need for techniques which allow for efficiently handling control signaling of remote UEs which are connected via a relay UE to the wireless communication network.

### SUMMARY

According to an embodiment, a method of controlling communication in a wireless communication network is provided. According to the method, a wireless device receives a first D2D communication message from a first other wireless device and a second D2D communication message from a second other wireless device. From the first D2D communication message, the wireless device decodes first UL control data from the first other wireless device. From the second D2D communication message, the wireless device decodes second UL control data from the second other wireless device. Further, the wireless device sends a UL message comprising the first UL control data and the second UL control data to a node of the wireless communication network.

According to a further embodiment, a method of controlling communication in a wireless communication network is provided. According to the method, a node of the wireless communication network receives a UL message from a wireless device. The UL message comprises first UL control data from a first other wireless device and second UL control data from a second other wireless device. From the UL message, the node decodes the first UL control data and the second UL control data. Based on the first UL control data, the node controls wireless communication of the first other wireless device. Based on the second UL control data, the node controls wireless communication of the second other wireless device.

According to a further embodiment, a method of controlling communication in a wireless communication network is provided. According to the method, a wireless device receives a DL message from a node of the wireless communication network. The DL message comprises first DL control data for a first other wireless device and second DL control data for a second other wireless device. From the DL message, the wireless device decodes the first DL control data and the second DL control data. Further, the wireless device sends one or more D2D communication messages to the first other wireless device and the second other wireless device. The one or more D2D communication messages comprise the first DL control data and the second DL control data.

According to a further embodiment, a method of controlling communication in a wireless communication network is provided. According to the method, a node of the wireless communication network sends a DL message to a wireless device having D2D connectivity to a first other wireless device and a second other wireless device. The DL message comprises first DL control data for the first other wireless device and second DL control data for the second other wireless device. The first DL control data controls wireless communication of the first other wireless device and the second DL control data controls wireless communication of the second other wireless device.

According to a further embodiment, a method of controlling communication in a wireless communication network is provided. According to the method, a wireless device receives a D2D communication message from a first other wireless device. The D2D communication message comprises first DL control data for the wireless device and second DL control data for a second other wireless device. The wireless device decodes at least the first DL control data from the D2D communication message. Based on the first DL control data, the wireless device communicates with a node of the wireless communication network and/or performs D2D communication.

According to a further embodiment, a wireless device for operation in a wireless communication network is provided. The wireless device is configured to receive a first D2D communication message from a first other wireless device and a second D2D communication message from a second other wireless device. Further, the wireless device is configured to decode, from the first D2D communication message, first UL control data from the first other wireless device. Further, the wireless device is configured to decode, from the second D2D communication message, second UL control data from the second other wireless device. Further, the wireless device is configured to send a UL message comprising the first UL control data and the second UL control data to a node of the wireless communication network.

According to a further embodiment, a wireless device for operation in a wireless communication network is provided. The wireless device comprises at least one processor and a memory. The memory contains instructions executable by said at least one processor, whereby the wireless device is operative to receive a first D2D communication message from a first other wireless device and a second D2D communication message from a second other wireless device. Further, the memory contains instructions executable by said at least one processor, whereby the wireless device is operative to decode, from the first D2D communication message, first UL control data from the first other wireless device. Further, the memory contains instructions executable by said at least one processor, whereby the wireless device is operative to decode, from the second D2D communication message, second UL control data from the second other wireless device. Further, the memory contains instructions executable by said at least one processor, whereby the wireless device is operative to send a UL message comprising the first UL control data and the second UL control data to a node of the wireless communication network.

According to a further embodiment, a node for a wireless communication network is provided. The node is configured to receive a UL message from a wireless device. The UL message comprises first UL control data from a first other wireless device and second UL control data from a second other wireless device. Further, the node is configured to decode the first UL control data and the second UL control data from the UL message. Further, the node is configured to control, based on the first UL control data, wireless communication of the first other wireless device. Further, the node is configured to control, based on the second UL control data, wireless communication of the second other wireless device.

According to a further embodiment, a node for a wireless communication network is provided. The node comprises at least one processor and a memory. The memory contains instructions executable by said at least one processor, whereby the node is operative to receive a UL message from a wireless device. The UL message comprises first UL control data from a first other wireless device and second UL control data from a second other wireless device. Further, the memory contains instructions executable by said at least one processor, whereby the node is operative to decode the first UL control data and the second UL control data from the UL message. Further, the memory contains instructions executable by said at least one processor, whereby the node is operative to control, based on the first UL control data, wireless communication of the first other wireless device. Further, the memory contains instructions executable by said at least one processor, whereby the node is operative to control, based on the second UL control data, wireless communication of the second other wireless device.

According to a further embodiment, a wireless device for operation in a wireless communication network is provided. The wireless device is configured to receive a DL message from a node of the wireless communication network. The DL message comprises first DL control data for a first other wireless device and second DL control data for a second other wireless device. Further, the wireless device is configured to decode the first DL control data and the second DL control data from the DL message. Further, the wireless device is configured to send one or more D2D communication messages to the first other wireless device and the second other wireless device. The one or more D2D communication messages comprise the first DL control data and the second DL control data.

According to a further embodiment, a wireless device for operation in a wireless communication network is provided. The wireless device comprises at least one processor and a memory. The memory contains instructions executable by said at least one processor, whereby the wireless device is operative to receive a DL message from a node of the wireless communication network. The DL message comprises first DL control data for a first other wireless device and second DL control data for a second other wireless device. Further, the memory contains instructions executable by said at least one processor, whereby the wireless device is operative to decode the first DL control data and the second DL control data from the DL message. Further, the memory contains instructions executable by said at least one processor, whereby the wireless device is operative to sends one or more D2D communication messages to the first other wireless device and the second other wireless device. The one or more D2D communication messages comprise the first DL control data and the second DL control data.

According to a further embodiment, a node for a wireless communication network is provided. The node is configured to send a DL message to a wireless device having D2D connectivity to a first other wireless device and a second other wireless device. The DL message comprises first DL control data for the first other wireless device and second DL control data for the second other wireless device. The first DL control data controls wireless communication of the first other wireless device and the second DL control data controls wireless communication of the second other wireless device.

According to a further embodiment, a node for a wireless communication network is provided. The node comprises at least one processor and a memory. The memory contains instructions executable by said at least one processor, whereby the node is operative to send a DL message to a wireless device having D2D connectivity to a first other wireless device and a second other wireless device. The DL message comprises first DL control data for the first other wireless device and second DL control data for the second other wireless device. The first DL control data controls wireless communication of the first other wireless device and the second DL control data controls wireless communication of the second other wireless device.

According to a further embodiment, a wireless device for operation in a wireless communication network is provided. The wireless device is configured to receive a D2D communication message from a first other wireless device. The D2D communication message comprises first DL control data for the wireless device and second DL control data for a second other wireless device. Further, the wireless device is configured to decode at least the first DL control data from the D2D communication message. Further, the wireless device is configured to, based on the first DL control data, communicate with a node of the wireless communication network and/or perform D2D communication.

According to a further embodiment, a wireless device for operation in a wireless communication network is provided. The wireless device comprises at least one processor and a memory. The memory contains instructions executable by said at least one processor, whereby the wireless device is operative to receive a D2D communication message from a first other wireless device. The D2D communication message comprises first DL control data for the wireless device and second DL control data for a second other wireless device. Further, the memory contains instructions executable by said at least one processor, whereby the wireless device is operative to decode at least the first DL control data from the D2D communication message. Further, the memory contains instructions executable by said at least one processor, whereby the wireless device is operative to, based on the first DL control data, communicate with a node of the wireless communication network and/or perform D2D communication.

According to a further embodiment of the invention, a computer program or computer program product is provided, e.g., in the form of a non-transitory storage medium, which comprises program code to be executed by at least one processor of a wireless device for operation in a wireless communication network. Execution of the program code causes the wireless device to receive a first D2D communication message from a first other wireless device and a second D2D communication message from a second other wireless device. Further, execution of the program code causes the wireless device to decode, from the first D2D communication message, first UL control data from the first other wireless device. Further, execution of the program code causes the wireless device to decode, from the second D2D communication message, second UL control data from the second other wireless device. Further, execution of the program code causes the wireless device to send a UL message comprising the first UL control data and the second UL control data to a node of the wireless communication network.

According to a further embodiment of the invention, a computer program or computer program product is provided, e.g., in the form of a non-transitory storage medium, which comprises program code to be executed by at least one processor of a node for a wireless communication network. Execution of the program code causes the node to receive a UL message from a wireless device. The UL message comprises first UL control data from a first other wireless device and second UL control data from a second other wireless device. Further, execution of the program code causes the node to decode the first UL control data and the second UL control data from the UL message. Further, execution of the program code causes the node to control, based on the first UL control data, wireless communication of the first other wireless device. Further, execution of the program code causes the node to control, based on the second UL control data, wireless communication of the second other wireless device.

According to a further embodiment of the invention, a computer program or computer program product is provided, e.g., in the form of a non-transitory storage medium, which comprises program code to be executed by at least one processor of a wireless device for operation in a wireless communication network. Execution of the program code causes the wireless device to receive a DL message from a node of the wireless communication network. The DL message comprises first DL control data for a first other wireless device and second DL control data for a second other wireless device. Further, execution of the program code causes the wireless device to decode the first DL control data and the second DL control data from the DL message. Further, execution of the program code causes the wireless device to send one or more D2D communication messages to the first other wireless device and the second other wireless device. The one or more D2D communication messages comprise the first DL control data and the second DL control data.

According to a further embodiment of the invention, a computer program or computer program product is provided, e.g., in the form of a non-transitory storage medium, which comprises program code to be executed by at least one processor of a node for a wireless communication network. Execution of the program code causes the node to send a DL message to a wireless device having D2D connectivity to a first other wireless device and a second other wireless device. The DL message comprises first DL control data for the first other wireless device and second DL control data for the second other wireless device. The first DL control data controls wireless communication of the first other wireless device and the second DL control data controls wireless communication of the second other wireless device.

According to a further embodiment of the invention, a computer program or computer program product is provided, e.g., in the form of a non-transitory storage medium, which comprises program code to be executed by at least one processor of a wireless device for operation in a wireless communication network. Execution of the program code causes the wireless device to receive a D2D communication message from a first other wireless device. The D2D communication message comprises first DL control data for the wireless device and second DL control data for a second other wireless device. Further, execution of the program code causes the wireless device to decode at least the first DL control data from the D2D communication message. Further, execution of the program code causes the wireless device to, based on the first DL control data, communicate with a node of the wireless communication network and/or perform D2D communication.

Details of such embodiments and further embodiments will be apparent from the following detailed description of embodiments.

### BRIEF DESCRIPTION OF THE DRAWINGS

FIG. 1 schematically illustrates a wireless communication network according to an embodiment.

FIG. 2 schematically illustrates an example of a scenario involving relaying of control data according to an embodiment.

FIG. 3 schematically illustrates a further example of a scenario involving relaying of control data according to an embodiment.

FIG. 4 schematically illustrates an example of processes of controlling wireless communication of multiple UEs based on relaying control data according to an embodiment.

FIG. 5 schematically illustrates a further example of processes of controlling wireless communication of multiple UEs based on relaying control data according to an embodiment.

FIG. 6 schematically illustrates a further example of processes of controlling wireless communication of multiple UEs based on relaying control data according to an embodiment.

FIG. 7 schematically illustrates a message format for conveying UL Control Information (UCI) according to an embodiment.

FIGS. 8A and 8B schematically illustrate message formats for conveying DL Control Information (DCI) according to an embodiment.

FIG. 9 shows a flowchart for schematically illustrating a method according to an embodiment.

FIG. 10 shows an exemplary block diagram for illustrating functionalities of a wireless device implementing functionalities corresponding to the method of FIG. 9.

FIG. 11 shows a flowchart for schematically illustrating a further method according to an embodiment.

FIG. 12 shows an exemplary block diagram for illustrating functionalities of a network node implementing functionalities corresponding to the method of FIG. 11.

FIG. 13 shows a flowchart for schematically illustrating a further method according to an embodiment.

FIG. 14 shows an exemplary block diagram for illustrating functionalities of a wireless device implementing functionalities corresponding to the method of FIG. 13.

FIG. 15 shows a flowchart for schematically illustrating a further method according to an embodiment.

FIG. 16 shows an exemplary block diagram for illustrating functionalities of a network node implementing functionalities corresponding to the method of FIG. 15.

FIG. 17 shows a flowchart for schematically illustrating a further method according to an embodiment.

FIG. 18 shows an exemplary block diagram for illustrating functionalities of a wireless device implementing functionalities corresponding to the method of FIG. 17.

FIG. 19 schematically illustrates structures of a network node according to an embodiment.

FIG. 20 schematically illustrates structures of a wireless device according to an embodiment.

### DETAILED DESCRIPTION

In the following, concepts in accordance with exemplary embodiments of the invention will be explained in more detail and with reference to the accompanying drawings. The illustrated embodiments relate to controlling of wireless communication between a wireless communication network and a wireless device (WD). The wireless communication network may be based on the 5G NR technology specified by 3GPP. However, other technologies could be used as well, e.g., the 4G LTE technology specified by 3GPP or a future 6G (6^{th} Generation) technology. The WD may correspond to various types of UEs or other types of WDs. As used herein, the term “wireless device” (WD) refers to a device capable, configured, arranged, and/or operable to communicate wirelessly with network nodes and/or other WDs. Unless otherwise noted, the term WD may be used interchangeably herein with UE. Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a Voice over IP (VOIP) phone, a wireless local loop phone, a desktop computer, a Personal Digital Assistant (PDA), a wireless camera, a gaming console or device, a music storage device, a playback appliance, a wearable terminal device, a wireless endpoint, a mobile station, a tablet, a laptop, Laptop Embedded Equipment (LEE), Laptop Mounted Equipment (LME), a smart device, a wireless Customer Premise Equipment (CPE), a vehicle mounted wireless terminal device, a connected vehicle, etc. In some examples, in an Internet of Things (IoT) scenario, a WD may also represent a machine or other device that performs monitoring and/or measurements, and transmits the results of such monitoring and/or measurements to another WD and/or a network node. The WD may in this case be a Machine-to-Machine (M2M) device, which may in a 3GPP context be referred to as a Machine-Type Communication (MTC) device. As one particular example, the WD may be a UE implementing the 3GPP Narrowband IoT (NB-IoT) standard. Particular examples of such machines or devices are sensors, metering devices such as power meters, industrial machinery, home or personal appliances (e.g., refrigerators, televisions, etc.), or personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

In the illustrated concepts, a WD acts as a relay node for one or more other WDs, and is thus herein also denoted as “relay WD”. In a UL direction, the relay WD may receive D2D transmissions with UL control data from the other WD(s). The relay WD may then send a UL message with the UL control data to a node of the wireless communication network, e.g., to an access node like. In some cases, the UL message may also convey DL control data from the relay WD itself. In a DL direction, the relay WD may receive a DL message from the node and decode DL control data for the other WD(s) from the DL message. The relay WD then sends one or more D2D communication messages to forward the DL control data to the respective other WD(s). In some cases, the DL message may also convey DL control data for the relay WD itself. The DL control data may include L1 DL control data, e.g., DCI (DL Control Information) and/or L2 control data, e.g., a MAC-CE. Similarly, the UL control data may include L1 UL control data, e.g., UCI (UL Control Information), and/or L2 control data, e.g., a MAC-CE. The UL message for conveying the combined UL control data of multiple WDs from the relay WD to the node can be a control channel transmission, e.g., on a PUCCH, or a shared channel transmission, e.g., on a PUSCH (Physical UL Shared Channel), or a combination of both. Such shared channel transmission may include the UL control data in a MAC-CE and/or in user payload data. The DL message for conveying the combined DL control data of multiple WDs from the node to the relay WD can be a control channel transmission, e.g., on a PDCCH, or a shared channel transmission, e.g., on a PDSCH (Physical DL Shared Channel), or a combination of both. Such shared channel transmission may include the DL control data in a MAC-CE and/or in user payload data. Accordingly, in the illustrated concepts the relay WD can act as a distribution point for control data and combine UL control data of multiple WDs for forwarding to the wireless communication network, and/or decombine DL control data received from the wireless communication network and destined to different WDs. As a result, the control data can be forwarded in an efficient manner.

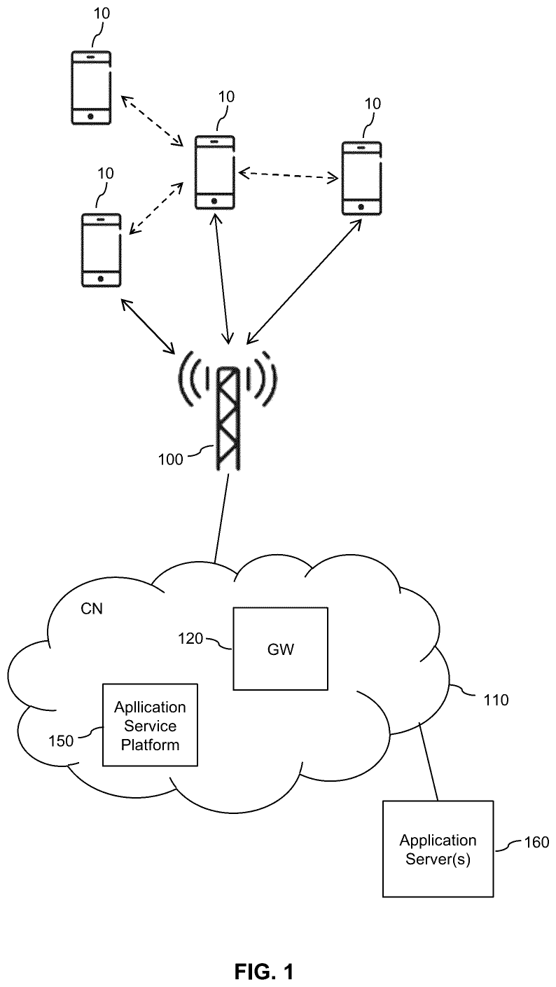

FIG. 1 illustrates exemplary structures of the wireless communication network. In particular, FIG. 1 shows UEs 10 which are served by an access nodes 100 of the wireless communication network. Here, it is noted that the wireless communication network may actually include a plurality of access nodes 100 that may serve a number of cells within the coverage area of the wireless communication network. The access nodes 100 may be regarded as being part of an RAN of the wireless communication network. Further, FIG. 1 schematically illustrates a CN (Core Network) 110 of the wireless communication network. In FIG. 1, the CN 110 is illustrated as including a GW (gateway) 120 and one or more control node(s) 140. The GW 120 may be responsible for handling user plane data traffic of the UEs 10, e.g., by forwarding user plane data traffic from a UE 10 to a network destination or by forwarding user plane data traffic from a network source to a UE 10. Here, the network destination may correspond to another UE 10, to an internal node of the wireless communication network, or to an external node which is connected to the wireless communication network. Similarly, the network source may correspond to another UE 10, to an internal node of the wireless communication network, or to an external node which is connected to the wireless communication network. The GW may for example correspond to a UPF (User Plane Function) of the 5G Core (EGC) or to an SGW (Serving Gateway) or PGW (Packet Data Gateway) of the 4G EPC (Evolved Packet Core). The control node(s) 140 may be used for controlling the user data traffic, e.g., by providing control data to the access node 100, the GW 120, and/or to the UE 10.

As illustrated by solid double-headed arrows, the access node 100 may send DL wireless transmissions to at least some of the UEs 10, and some of the UEs 10 may send UL wireless transmissions to the access node 100. As further illustrated by broken double-headed arrows, some of the UEs 10 may communicate directly with each other, i.e., perform D2D communication. Such D2D communication may be based on a SL communication mode using the PC5 interface as specified in the 4G LTE technology or the 5G NR technology. However, other kinds of D2D communication modes could be used as well. The DL transmissions, UL transmissions, and the D2D transmissions may be performed in a licensed spectrum, in a license exempt spectrum, or in a combination of licensed spectrum and license exempt spectrum. The DL transmissions, UL transmissions, and the D2D transmissions may be based on an FDD (Frequency Division Duplex) or a TDD (Time Division Duplex) mode. Still further, a UE 10 could also be out of coverage of the wireless communication network and not be capable of receiving DL transmissions from any access node 100 or sending UL transmissions to any access node 100. Such UE 10 may however still communicate with the access node 100, by using another UE 10 as relay UE. A UE 10 which communicates via a relay UE with an access node of the wireless communication network is herein also denoted as remote UE.

The DL transmissions and UL transmissions may be used to provide various kinds of services to the UEs 10, e.g., a voice service, a multimedia service, or a data service. Such services may be hosted in the CN 110, e.g., by a corresponding network node. By way of example, FIG. 1 illustrates an application service platform 150 provided in the CN 110. Further, such services may be hosted externally, e.g., by an AF (application function) connected to the CN 110. By way of example, FIG. 1 illustrates one or more application servers 160 connected to the CN 110. The application server(s) 160 could for example connect through the Internet or some other wide area communication network to the CN 110. The application service platform 150 may be based on a server or a cloud computing system and be hosted by one or more host computers. Similarly, the application server(s) 160 may be based on a server or a cloud computing system and be hosted by one or more host computers. The application server(s) 160 may include or be associated with one or more AFs that enable interaction with the CN 110 to provide one or more services to the UEs 10, corresponding to one or more applications. These services or applications may generate the user data traffic conveyed by the DL transmissions and/or the UL transmissions between the access node(s) 100 and the respective UE 10. Accordingly, the application server(s) 160 may include or correspond to the above-mentioned network destination and/or network source for the user data traffic. In the respective UE 10, such service may be based on an application (or shortly “app”) which is executed on the UE 10. Such application may be pre-installed or installed by the user. Such application may generate at least a part of the UP traffic between the UE 10 and the access node 100.

In the illustrated concepts, one or more of the UEs 10 may act as a relay UE for one or more other UEs 10, which then correspond to remote UEs. In a UL direction, the relay UE 10 may receive D2D transmissions with UL control data from the remote UE(s) 10. The relay UE 10 may then send a UL transmission with the UL control data to the access node 100. In some cases, the UL transmission may also convey DL control data from the relay UE 10 itself. In a DL direction, the relay UE 10 may receive a DL transmission from the access node 100 and decode DL control data for the remote UE(s) 10 from the DL transmission. The relay UE 10 then sends one or more D2D transmissions to forward the DL control data to the respective remote UE(s).

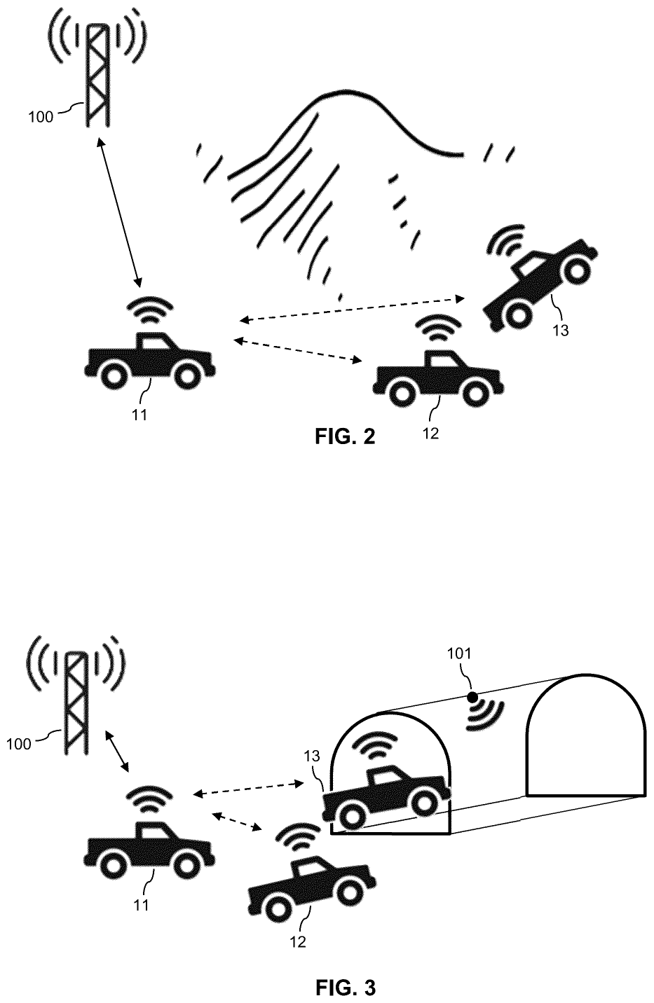

In the following the illustrated concepts will be further explained by referring to exemplary use case scenarios as illustrated in FIGS. 2 and 3. These scenarios assume vehicle-based UEs 11, 12, 13. The vehicle-based UEs 11, 12, 13 may for example use D2D communication, DL communication, and/or UL communication for implementing one or more V2X (vehicle-to-anything) communication services.

In the example of FIG. 2, UE 11 has DL/UL connectivity to an access node 100 of the wireless communication network, i.e., is in network coverage. The UEs 12, 13 are however out of network coverage. The UEs 12, 13 may however indirectly connect to the access node 100, using the UE 11 as relay UE. In the scenario of FIG. 2, the UE 11 thus acts as relay UE for remote UEs 12, 13. The relaying of the UL control data and/or DL control data by the relay UE 11 may be based on packaging the UL/DL control data in messages conveyed on interfaces between remote UE 12, 13 and relay UE 11 and between relay UE 11 and access node 100. For example, of the remote UE 12, 13 sends UCI via the relay UE 11 to the access node 100, the remote UE 12, 13 may package the UCI may be packaged in SCI (SL Control Information) sent over the SLCCH (SL Control Channel) or as data sent over the SLSCH (SL Shared Channel). The relay UE 11 may then package the UCI from the remote UE 12, 13 in UCI of the relay UE 11 sent over the PUCCH or in data sent over the PUSCH. Similarly, if the access node 100 sends DCI to the remote UE 12, 13, the access node 100 may package the DCI in DCI sent over the PDCCH to the relay UE 11 or in data sent over the PDSCH to the relay UE 11. The relay UE 11 may forward the DCI for the remote UE 12, 13 in SCI sent over the SLCCH or as data sent over the SLSCH. The relaying of L2 control data, e.g., MAC-CEs, may be performed in a corresponding manner. In the scenario of FIG. 2, the UL control data and DL control data may for example relate to scheduling of transmissions by the remote UE 12, 13. For example, the UL control data from the remote UE 12, 13 could include a SR and/or a BSR, and the DL control data from the access node 100 could include DCI for scheduling a SL or UL transmission by the remote UE 12, 13. By relaying the UL/DL control data, such scheduling is possible, even if the remote UE 12, 13 is temporarily out of coverage, e.g., due to shadowing by landscape features, buildings, or otherwise poor channel conditions.

The scenario of FIG. 3 is similar to that of FIG. 2, but involves an additional access node 101 providing coverage in an area which is not accessible for signals from the access node 100, e.g., in a tunnel. In such scenario, the UL/DL control data relayed by the relay UE 12, 13 may relate to a handover (HO) of the remote UE 12, 13 from the access node 100 to the access node 101. Upon entry into the tunnel, the remote UE 12, 13 may abruptly move out of coverage of the access node 100, so that the access node 100 is not able to directly send DL control data with a HO command to the remote UE 12, 13. In the illustrated concepts, such DL control data can however be relayed by the relay UE 11 and thus still reach the remote UE 12, 13.

In the scenarios of FIGS. 2 and 3, the remote UEs 12 may send its UL control data to the relay UE 11, and also the remote UE 13 may send its UL control data to the relay UE 11. The relay UE 11 may then combine the UL control data from the remote UEs 12, 13 and forward the combined UL control data in the same message to the access node 100, optionally also including UL control data from the relay UE 11. Similarly, if the access node 100 intends to provide respective DL control data to both remote UEs 12, 13, the access node 100 may combine the DL control data in the same message to the relay UE 11. In some cases, this message could also include DL control data for the relay UE 11.

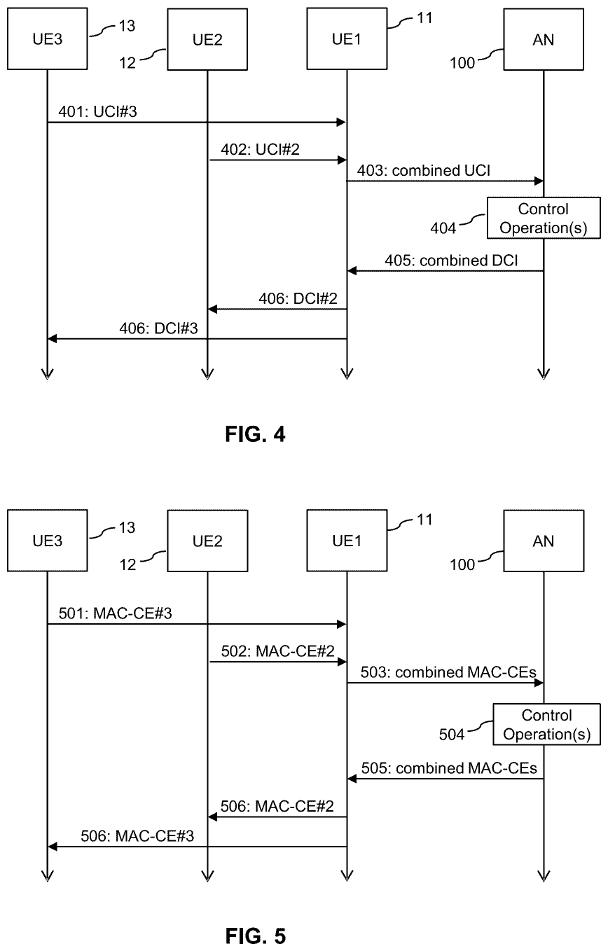

FIG. 4 illustrates exemplary process involving relaying of UL/DL control data in accordance with the illustrated concepts. The process of FIG. 4 involve an access node 100, a first UE 11 (UE1), a second UE 12 (UE2), and a third UE3 (UE3). The UE 11 acts as a relay UE for the UEs 12, 13, which thus correspond to remote UEs. The UEs 11, 12, 13, and the access node 100 may for example correspond to UEs 10, 11, 12, 13 and to the access node 100 in the examples of FIG. 1, 2, or 3.

In the example of FIG. 4, the relay UE 11 receives UCI (UCI #3) from UE 13 in a D2D transmission 401 from UE 13. Further, the relay UE 11 receives UCI (UCI #2) from UE 12 in a D2D transmission 402 from UE 12. The UCI from the different remote UEs may be of the same type or of different types. For example, the UCI from UE 13 could include a SR and/or HARQ feedback from UE 13 and the UCI from UE 12 could include a CSI (Channel State Information) report related to the channel from UE 12 to the access node 100 or a CSI report related to the channel between the UE 12 and the relay UE 11. The relay UE 11 then combines the UCI from UE 13 and the UCI from UE 12 to combined UCI. Optionally, the combined UCI may also include UCI from the relay UE 11, e.g., a SR from UE 11. The relay UE 11 then sends the combined UCI in a single combined UCI message 403 to the access node 100. Based on the received UCI, the access node 100 then performs one or more control operations related to the UEs 11, 12, 13, e.g., by scheduling one or more wireless transmissions, as indicated by block 404. Based on the control operation(s), the access node 100 then determines DCI for UEs 12, 13, e.g., a UL grant for UE 13 and a UL grant for UE 12. Further, the access node 100 may determine DCI for the relay UE 11, 13, e.g., a UL grant. The access node 100 combines the DCI for the UE 12, the DCI for UE 13, and optionally the DCI for UE 11 in a single combined DCI message 405 to the UE 11. The relay UE 11 decodes the different DCI from the combined DCI message 405 and forwards the DCI to its respective destination, by including the DCI for UE 12 in a D2D transmission to UE 12 and by including the DCI for UE 13 in a D2D transmission to UE 13.

It is noted that in some cases the D2D transmission 401 from UE 13 to the relay UE 11 may also include control data which are destined to the relay UE 11, e.g., a CSI report related to the channel between the UE 13 and the relay UE 11. Similarly, the D2D transmission 402 from UE 12 to the relay UE 11 may also include control data which are destined to the relay UE 11, e.g., a CSI report related to the channel between the UE 12 and the relay UE 11. Such control data which is destined to the relay UE 11 does not need to be relayed by the relay UE 11. The relay UE 11 may thus select the UCI to be combined and relayed from the received D2D transmissions 401, 402. Such selection could be based on decoding and interpreting the received control data. Another possibility would be that the relay UE 11 determines from a resource mapping which part of the received control data is to be combined and relayed. For example, the UCI which needs to be relayed may be transmitted on a corresponding set of one or more radio resources. Further, such mapping may also indicate from which remote UE 12, 13 the UCI originates. For example such radio resources could be mapped to UE identifiers which also indicate of that relaying is required. Such mapping could for example be configured by RRC (Radio Resource Control) signaling.

FIG. 5 illustrates further exemplary process involving relaying of UL/DL control data in accordance with the illustrated concepts. The process of FIG. 5 involve an access node 100, a first UE 11 (UE1), a second UE 12 (UE2), and a third UE3 (UE3). The UE 11 acts as a relay UE for the UEs 12, 13, which thus correspond to remote UEs. The UEs 11, 12, 13, and the access node 100 may for example correspond to UEs 10, 11, 12, 13 and to the access node 100 in the examples of FIG. 1, 2, or 3.

In the example of FIG. 5, the relay UE 11 receives a MAC-CE (MAC-CE #3) from UE 13 in a D2D transmission 501 from UE 13. Further, the relay UE 11 receives a MAC-CE (MAC-CE #2) from UE 12 in a D2D transmission 502 from UE 12. The MAC-CEs from the different remote UEs may be of the same type or of different types. For example, the MAC-CE from UE 13 could include a BSR from UE 13 and the MAC-CE from UE 12 could include a PHR (Power Headroom Report) from UE 12. The relay UE 11 then combines the MAC-CE from UE 13 and the UCI from UE 12 to combined MAC-CEs. Optionally, the combined MAC-CEs may also include a MAC-CE from the relay UE 11, e.g., a BSR from UE 11. The relay UE 11 then sends the combined MAC-CEs in a single combined MAC-CEs message 503 to the access node 100. Based on the received MAC-CEs, the access node 100 then performs one or more control operations related to the UEs 11, 12, 13, e.g., by scheduling one or more wireless transmissions, as indicated by block 504. Based on the control operation(s), the access node 100 then determines MAC-CEs for UEs 12, 13, e.g., link adaptation information for UE 13 and link adaptation information for UE 12. Further, the access node 100 may determine a MAC-CE for the relay UE 11, 13, e.g., link adaptation information. The access node 100 combines the MAC-CE for the UE 12, the MAC-CE for UE 13, and optionally the MAC-CE for UE 11 in a single combined MAC-CEs message 505 to the relay UE 11. The relay UE 11 decodes the different MAC-CEs from the combined MAC-CEs message 505 and forwards each MAC-CE to its respective destination, by including the MAC-CE for UE 12 in a D2D transmission to UE 12 and by including the MAC-CE for UE 13 in a D2D transmission to UE 13.

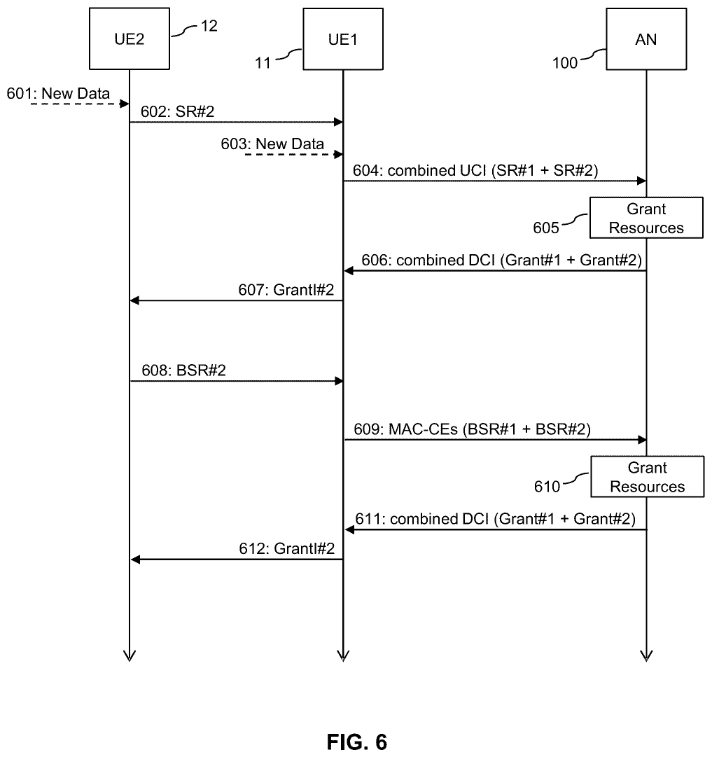

FIG. 6 illustrates further exemplary process involving relaying of UL/DL control data in accordance with the illustrated concepts. The process of FIG. 6 involve an access node 100, a first UE 11 (UE1), and a second UE 12 (UE2). The UE 11 acts as a relay UE for the UE 12, which thus correspond to a remote UE. The UEs 11, 12 and the access node 100 may for example correspond to any of UEs 10, 11, 12, 13 and to the access node 100 in the examples of FIG. 1, 2, or 3.

In the example of FIG. 6, the UE 12 receives new data 601 to be transmitted to the access node 100. The UE 12 thus sends a D2D transmission 602 including UCI with a SR (SR #2) to the relay UE 11. Further, also the relay UE 11 receives new data 603 to be transmitted to the access node 100 and locally generates UCI with a SR (SR #1). The relay UE 11 decodes the UCI from the D2D transmission 602 and combines it with the locally generated UCI. The relay UE 11 then sends the combined UCI in a single combined UCI message 604 to the access node 100. The access node 100 decodes the UCI from the UE 12 and the UCI from the UE 11 and, based on the SRs in the received UCI, grants resources to the UE 11 and to the UE 12, as indicated by block 605. The access node 100 thus determines DCI with a UL grant (Grant #1) for the UE 11 and DCI with a UL grant (Grant #2) for the UE 12. The access node 100 combines the DCI for UE 11 and the DCI for UE 12 in a single combined DCI message 606 to the relay UE 11. The relay UE 11 decodes the different DCI from the combined DCI message 606 and forwards the DCI for UE 12, by including the DCI for UE 12 in a D2D transmission 607 to UE 12.

The UE 12 then sends a D2D transmission 608 including a MAC-CE with a BSR (BSR #2) to the relay UE 11. Further, also the relay UE 11 locally generates a MAC-CE with a BSR (BSR #1). The relay UE 11 decodes the MAC-CE from the D2D transmission 608 and combines it with the locally generated MAC-CE. The relay UE 11 then sends the combined MAC-CEs in a single combined MAC-CEs message 609 to the access node 100. The access node 100 decodes the MAC-CE from the UE 12 and the MAC-CE from the UE 11 and, based on the BSRs in the received MAC-CEs, grants further resources to the UE 11 and to the UE 12, as indicated by block 610. The access node 100 thus determines DCI with a UL grant (Grant #1) for the UE 11 and DCI with a UL grant (Grant #2) for the UE 12. The access node 100 combines the DCI for UE 11 and the DCI for UE 12 in a single combined DCI message 611 to the relay UE 11. The relay UE 11 decodes the different DCI from the combined DCI message 611 and forwards the DCI for UE 12, by including the DCI for UE 12 in a D2D transmission 612 to UE 12.

Processes like illustrated in FIG. 6 may for example be used for implementing a 4-step random access or a 2-step random access in which the relay UE can send a SRs also for one or more other UEs.

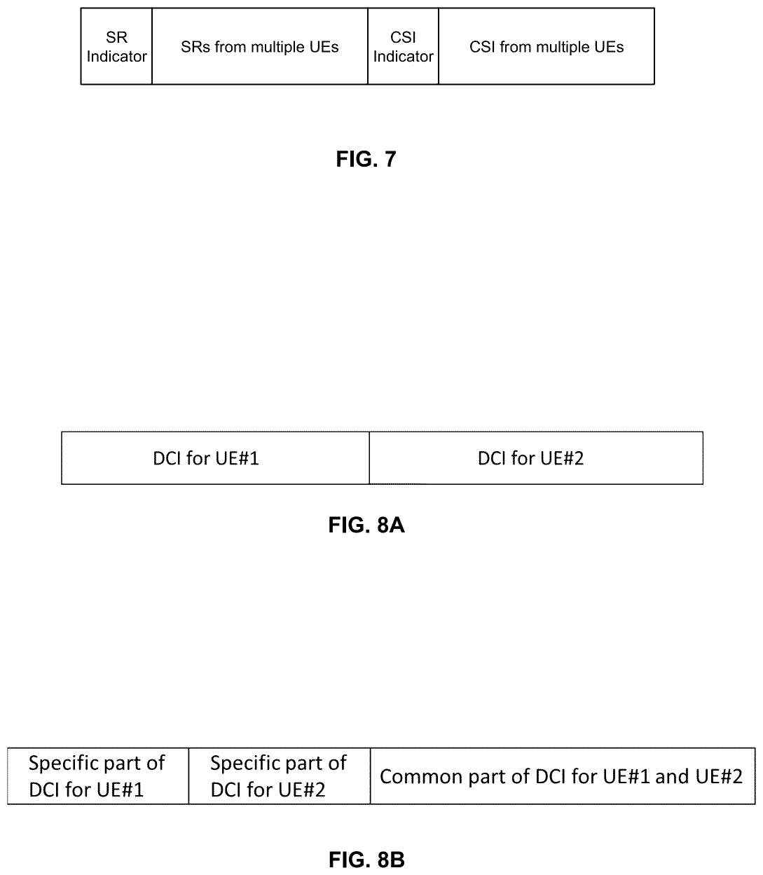

As mentioned above, the combined UCI can combine different types of UCI, e.g., a SR, a CSI report, and/or HARQ (Hybrid Automatic Repeat Request) feedback. In such case, the combined UCI may also include corresponding indicators of the type of individual UCI included therein. FIG. 7 shows an example of a corresponding format of the combined UCI. In the example of FIG. 7, the combined UCI includes an SR indicator, indicating UCI of the type “SR”, followed by one or more SRs from different remote UEs, and a CSI indicator, indicating UCI of the type “CSI report”, followed by CSI reports from different remote UEs. In other cases, the combined UCI could include only one type of UCI, however from different remote UEs. In such case, different combined UCI messages may be needed to transmit different types of UCI.

FIGS. 8A and 8B schematically illustrate example formats of the combined DCI. In the example of FIG. 8A, the combined DCI includes the individual DCI of the different UEs concatenated to each other. In the example of FIG. 8B, the combined DCI uses a more resource efficient format, including a UE-specific with individual for each of the different UEs, and a common part with DCI that applies to all the UEs addressed by the DCI. The combined DCI may be scrambled with the individual RNTI (Radio Network Temporary Identity) of the relay UE or by a group RNTI assigned to the remote UEs and the relay UE.

In UL transmission, the access node may apply various mechanisms to determine to which of the different UEs the received UL control data relate. The method applied by the relay UE to combine the UL control data of the different UEs may be known to the access node, e.g., by standardized pre-configuration, RRC configuration, e.g., during connection setup, or some other higher layer signaling.

In some scenarios, the combining may be based on a bitmap: In this case, the location of each UE's UL control data in a bitstream of the combined UL control data is known to the access node. For example, the location and size of each UE's UL control data in the bitstream may be defined by RRC configuration. Zero padding may be used for those UEs that do not have any UL control data to be forwarded. The latter may allow for maintaining a fixed size of the combined UL control data.

In some scenarios, the combing may be based on UE identifiers: In this case, a UE identifier at the beginning of UL control data item in the combined UL control data may indicate the UE to which this UL control data item relates. A further possibility would be to determine the UE to which this UL control data item relates by applying an XOR operation to the UE identifier and the UL control data item. Still further, the UL control data item could be scrambled with the respective UE identifier. An RNTI or a DMRS (Demodulation Reference Signal) sequence may be used as the UE identifier.

In some scenarios, the combing may be based on assigning a group identifier to a group of UEs. In this case, the group identifier may be sent together with the combined UL control data to indicate that the combined UL control data applies to all UEs of the group. The group identifier and the assignment of the UEs to the group may be configured by RRC configuration or other higher layer signaling. A group RNTI can be used as the group identifier.

In some scenarios, the combing may be based on resource mapping: For example, different frequency and/or time resources may be assigned to the UL control data of different UEs. In this case, the access node may derive the UE to which a specific UL control data item relates from the specific frequency and/or time resources on which the access node receives the UL control data item. For example, a certain frequency subband or a number of carriers could be assigned to a specific UE, so that the access node can assume that the UL control data received on this subband or these carriers relates to the specific UE. The mapping of UEs to the frequency/time resources may be configured by RRC configuration or other higher layer signaling.

In DL transmission, the relay UE may apply various mechanisms to determine to which of the different UEs the received DL control data relate. The method applied by the access node to combine the DL control data of the different UEs may be known to the relay UE, e.g., by standardized pre-configuration, RRC configuration, e.g., during connection setup, or some other higher layer signaling.

In some scenarios, the combining may be based on a bitmap: In this case, the location of each UE's DL control data in a bitstream of the combined DL control data is known to the relay UE. For example, the location and size of each UE's DL control data in the bitstream may be defined by RRC configuration. Zero padding may be used for those UEs without any DL control data. The latter may allow for maintaining a fixed size of the combined DL control data.

In some scenarios, the combing may be based on UE identifiers: In this case, a UE identifier at the beginning of DL control data item in the combined DL control data may indicate the UE to which this DL control data item relates. A further possibility would be to determine the UE to which this DL control data item relates by applying an XOR operation to the UE identifier and the DL control data item or to the UE identifier and a CRC (Cyclic Redundancy Check) value of the DL control data. Still further, the DL control data item could be scrambled with the respective UE identifier. An RNTI or a DMRS sequence may be used as the UE identifier.

In some scenarios, the combing may be based on assigning a group identifier to a group of UEs. In this case, the group identifier may be sent together with the combined UL control data to indicate that the combined UL control data applies to all UEs of the group. The group identifier and the assignment of the UEs to the group may be configured by RRC configuration or other higher layer signaling. A group RNTI can be used as the group identifier.

In some scenarios, the combing may be based on resource mapping: For example, different frequency and/or time resources may be assigned to the DL control data of different UEs. In this case, the relay UE may derive the UE to which a specific DL control data item relates from the specific frequency and/or time resources on which the relay UE receives the DL control data item. For example, a certain frequency subband or a number of carriers could be assigned to a specific UE, so that the relay UE can assume that the DL control data received on this subband or these carriers relates to the specific UE. The mapping of UEs to the frequency/time resources may be configured by RRC configuration or other higher layer signaling.

In some scenarios, the combined UL control data may include LI UL control data of multiple UEs, e.g., UCI of multiple UEs. These multiple UEs may also include the relay UE. Further, the combined UL control data may include L2 UL control data of multiple UEs, e.g., MAC-CEs. In some cases, the combined UL control data may also include both L1 UL control data and L2 UL control data of multiple UEs, e.g., a combination of UCI and one or more MAC-CEs. Similarly, the combined DL control data may include L1 DL control data of multiple UEs, e.g., DCI of multiple UEs. These multiple UEs may also include the relay UE. Further, the combined DL control data may include L2 DL control data of multiple UEs, e.g., MAC-CEs. In some cases, the combined DL control data may also include both L1 DL control data and L2 DL control data of multiple UEs, e.g., a combination of DCI and one or more MAC-CEs.

For conveying DL control data to a group of UEs, the following procedure may be followed: The access node determines D2D communication capabilities of UEs served by the access node and groups the UEs. A group of UEs can for example include UEs that are located close to each other so that they are in D2D communication range of each other. Then the access node selects UE from the group which is suitable to act as a relay UE for the other UEs of the group. The access node then informs the UEs of the group about the selected relay UE, e.g., by RRC configuration, DCI, and/or SCI. Based on measured parameters, e.g., network load, UE's battery life, or the like, the access node may then decide on a case by case basis whether to transmit DL control data to UEs in the group via the relay UE or in one or more direct DL transmissions. If the access node decides to send the DL control data via the relay UE, the access node sends the DL control data in a combined DL control data message to the relay UE. The relay UE decodes the received message and forwards the DL control data to the respective destination UEs.

For conveying UL control data from a group of UEs, the following procedure may be followed:

The access node determines D2D communication capabilities of UEs served by the access node and groups the UEs. A group of UEs can for example include UEs that are located close to each other so that they are in D2D communication range of each other. Then the access node selects UE from the group which is suitable to act as a relay UE for the other UEs of the group. The access node then informs the UEs of the group about the selected relay UE, e.g., by RRC configuration, DCI, and/or SCI. If a part of UEs are in coverage of the access node, the access node may schedule for each of these UEs whether the transmission of the UL control data shall be via the relay UE or by direct UL transmission to the access node and inform each of the UEs accordingly. If a UE of the group sends its UL control data via the relay UE, such UE includes the UL control data in a D2D transmission to the relay UE. The relay UE combines the UL control data of multiple UEs and sends to the combined UL control data in a combined UL control data message to the access node.

The grouping of the UEs may be based on various criteria and generally aims at enabling the utilization of one UE in the group as relay UE for other UEs in the group. This is typically possible if the UEs of the groups are located in proximity of each other. The grouping may for example involve grouping UEs which are being served by the same beam or at least adjacent beams. Alternatively or in addition, the grouping may involve grouping UEs using the same services or the same traffic types. Alternatively or in addition, the grouping may involve grouping UEs using services with similar QoS (Quality of Service) requirements. Alternatively or in addition, the grouping may involve grouping UEs located in the same proximity area. Alternatively or in addition, the grouping may involve grouping UEs with similar capabilities. Alternatively or in addition, the grouping may involve grouping UEs with similar access rights, e.g., associated with the same access categories or in the same or at least similar access groups.

The relay UE may be selected based on channel conditions. For example, the UE in the group which has the best quality of radio connection to the access node, e.g., in terms of signal strength and/or signal quality, can be selected as the relay UE. In some cases, the group could also have multiple relay UEs. The role of the relay UE can be changed from time to time, e.g., depending on variations of the radio connection strengths of the UEs in the group. In some case, it is also possible to define a threshold for the radio connection quality and to assign each UE of the group which has a radio connection quality above the threshold as relay UE.

As mentioned above, in some cases the UL control data may also include a PHR from a remote UE. For providing PHRs from the group of UEs to the access node, the UEs of the group may send their respective PHR to the relay UE, which combines the PHRs from the different UEs to in a single UL control data message to the access node. The combined PHRs may be sent in a MAC-CE over the PUSCH. Depending on whether the relay UE has a UL grant for transmitting on the PUSCH, one of the following procedures may be followed: If the relay UE has a UL grant, the relay UE sends the combined PHRs of all UEs of the group. If the relay UE does not have a UL grant, the relay UE first sends a SR to the access node to obtain a UL grant for transmitting the combined PHRs to the access node.

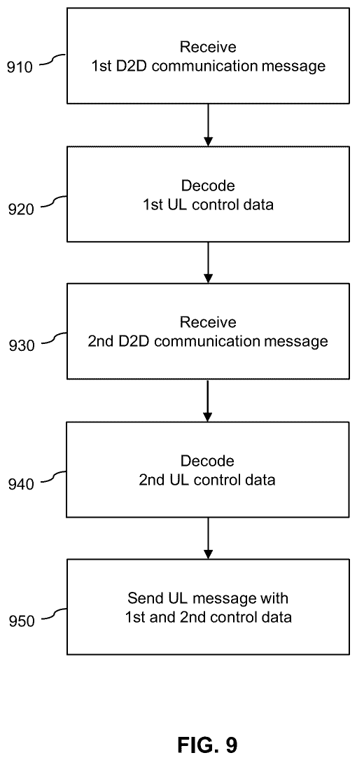

FIG. 9 shows a flowchart for illustrating a method, which may be utilized for implementing the illustrated concepts. The method of FIG. 9 may be used for implementing the illustrated concepts in a WD operating in a wireless communication network. For example, the WD may correspond to any of the above-mentioned UEs 10, 11, 12. In the method of FIG. 9, the WD acts as a relay UE

If a processor-based implementation of the WD is used, at least some of the steps of the method of FIG. 9 may be performed and/or controlled by one or more processors of the WD. Such WD may also include a memory storing program code for implementing at least some of the below described functionalities or steps of the method of FIG. 9.

At step 910, the WD receives a first D2D communication message from a first other WD. The first other WD may correspond to a UE, e.g., one of the above-mentioned UEs 10, 11, 12, 13. In particular, the first other WD may be a remote UE, such as the above-mentioned UE 12 or 13.

At step 920, the WD decodes first UL control data from the first D2D communication message. The first UL control data originate from the first other WD. The first UL control data may include first physical layer UCI from the first other WD. The first physical layer UCI may include a SR from the first other WD and/or CSI from the first other WD, and/or an acknowledgement for DL data transmitted to the first other WD, e.g., HARQ feedback. Alternatively or in addition, the first UL control data may include at least one first MAC-CE from the first other WD. The at least one first MAC-CE may include a BSR, and/or a PHR.

At step 930, the WD receives a second D2D communication message from a second other WD. The second other WD may correspond to a UE, e.g., one of the above-mentioned UEs 10, 11, 12, 13. In particular, the second other WD may be a remote UE, such as the above-mentioned UE 12 or 13.

At step 940, the WD decodes second UL control data from the second D2D communication message. The second UL control data originate from the second other WD. The second UL control data may include second physical layer UCI from the second other WD. The second physical layer UCI may include a SR from the second other WD, CSI from the second other WD, and/or an acknowledgement for DL data transmitted to the second other WD, e.g., HARQ feedback. Alternatively or in addition, the second UL control data include at least one second MAC-CE from the second other WD. The at least one second MAC-CE may include a BSR, and/or a PHR.

At step 950, the WD sends a UL message to a node of the wireless communication network. The node may for example be an access node of the wireless communication network, such as the above-mentioned access nodes 100, 101. The UL message to the node includes the first UL control data and the second UL control data. In some scenarios, the UL message further includes user plane data from the WD device and/or UL control data from the WD.

The UL message may indicate an association of the first UL control data to the first other WD and an association of the second UL control data to the second other WD. This association may be indicated by at least one of: the UL message including an identifier of the first other WD, the UL message including an identifier of the second other WD, the UL message including a group identifier of a group of WDs comprising at least the first other WD and the second other WD, a configured bit mapping which maps the first other WD to a first part of the UL message and maps the second other wireless device to a second part of the UL message, and a configured resource mapping which maps the first other WD to a first part of resources used for transmission of the UL message and maps the second other WD to a second part of the resources used for transmission of the UL message. The first and second part of the UL message may for example correspond to different parts of a bitstream of the UL message. The first and second resources may for example correspond to different frequency resources and/or different time resources.

In some scenarios, the WD may also receive a DL message from the node. The DL message may include first DL control data for the first other WD. From the DL message, the WD may then decode the first DL control data. The WD may then send a D2D communication message including the first DL control data to the first other WD. Alternatively or in addition, the WD may receive a DL message from the node which includes second DL control data for the second other WD. From the DL message, the WD may then decode the second DL control data. The WD may then send a D2D communication message including the second DL control data to the second other WD. In some cases, the WD may decode the first DL control data and the second DL control data from the same DL message.

The first DL control data may include first physical layer DCI for the first other WD. The first physical layer DCI may include a resource assignment for a UL transmission from the first other WD, a resource assignment for a DL transmission to the first other WD, and/or a resource assignment for D2D communication by the first other WD. In addition or as an alternative, the first physical layer DCI may include an acknowledgement for UL data transmitted from the first other WD to the node, e.g., HARQ feedback. The second DL control data may include second physical layer DCI for the second other WD. The second physical layer DCI may include a resource assignment for a UL transmission from the second other WD, a resource assignment for a DL transmission to the second other WD, and/or a resource assignment for D2D communication by the second other WD. In addition or as an alternative, the second physical layer DCI may include an acknowledgement for UL data transmitted from the second other WD to the node, e.g., HARQ feedback. In addition or as an alternative, the first DL control data may include at least one first MAC-CE for the first other WD, e.g., a MAC-CE including a DRX (Discontinuous Reception) command. The second DL control data may include at least one second MAC-CE for the second other WD, e.g., a MAC-CE including a DRX command.

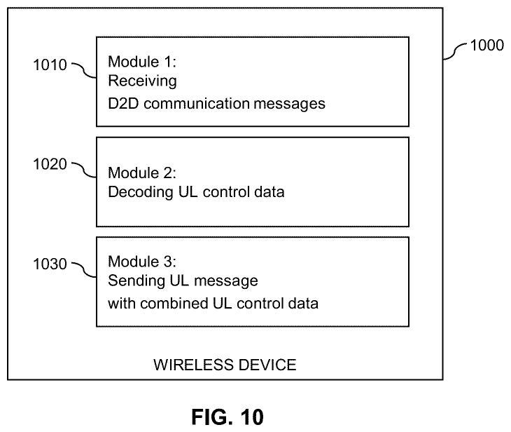

FIG. 10 shows a block diagram for illustrating functionalities of a WD 1000 for a wireless communication network which operates according to the method of FIG. 9. The WD 1000 may for example correspond to above-mentioned UEs 10, 11, 12, 13. As illustrated, the WD 1000 may be provided with a module 1010 configured to receive D2D communication messages, such as explained in connection with steps 910 and 930. Further, the WD 1000 may be provided with a module 1020 configured to decode UL control data, such as explained in connection with steps 920 and 940. Further, the WD 1000 may be provided with a module 1030 configured to send a UL message with combined UL control data, such as explained in connection with step 950.

It is noted that the WD 1000 may include further modules for implementing other functionalities, such as known functionalities of a UE in the LTE or NR technology. Further, it is noted that the modules of the WD 1000 do not necessarily represent a hardware structure of the WD 1000, but may also correspond to functional elements, e.g., implemented by hardware, software, or a combination thereof.

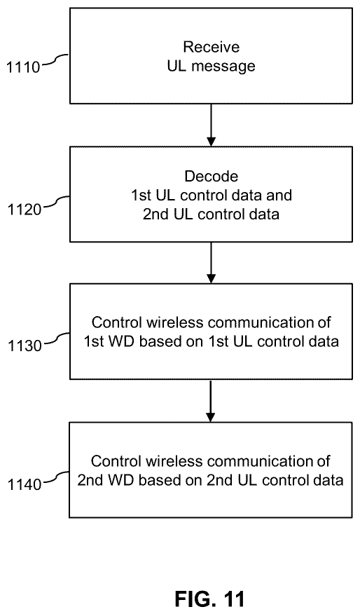

FIG. 11 shows a flowchart for illustrating a method, which may be utilized for implementing the illustrated concepts. The method of FIG. 11 may be used for implementing the illustrated concepts in a node of a wireless communication network. For example, the node may correspond to an access node, such as one of the above-mentioned access nodes 100, 101.

If a processor-based implementation of the node is used, at least some of the steps of the method of FIG. 11 may be performed and/or controlled by one or more processors of the node. Such node may also include a memory storing program code for implementing at least some of the below described functionalities or steps of the method of FIG. 11.

At step 1110, the node receives a UL message from a WD. The WD may be a UE, e.g., one of the above-mentioned UEs 10, 11, 12, 13. In particular, the WD may be a relay UE, such as the above-mentioned UE 11. The UL message includes first UL control data from a first other WD and second UL control data from a second other WD. The first other WD may correspond to a UE, e.g., one of the above-mentioned UEs 10, 11, 12, 13. In particular, the first other WD may be a remote UE, such as the above-mentioned UE 12 or 13. Also the second other WD may correspond to a UE, e.g., one of the above-mentioned UEs 10, 11, 12, 13. In particular, the second other WD may be a remote UE, such as the above-mentioned UE 12 or 13. In some scenarios, the UL message further includes user plane data from the WD device and/or UL control data from the WD.

The first UL control data may include first physical layer UCI from the first other WD. The first physical layer UCI may include a SR from the first other WD, CSI from the first other WD, and/or an acknowledgement for DL data transmitted to the first other WD, e.g., HARQ feedback. Alternatively or in addition, the first UL control data may include at least one first MAC-CE from the first other WD. The at least one first MAC-CE may include a BSR and/or a PHR. The second UL control data may include second physical layer UCI from the first other WD. The second physical layer UCI may include a SR from the second other WD, CSI from the second other WD, and/or an acknowledgement for DL data transmitted to the second other WD, e.g., HARQ feedback. Alternatively or in addition, the second UL control data include at least one second MAC-CE from the second other WD. The at least one second MAC-CE may include a BSR and/or a PHR.

The UL message may indicate an association of the first UL control data to the first other WD and an association of the second UL control data to the second other WD. This association may be indicated by at least one of: the UL message including an identifier of the first other WD, the UL message including an identifier of the second other WD, the UL message including a group identifier of a group of WDs comprising at least the first other WD and the second other WD, a configured bit mapping which maps the first other WD to a first part of the UL message and maps the second other wireless device to a second part of the UL message, and a configured resource mapping which maps the first other WD to a first part of resources used for transmission of the UL message and maps the second other WD to a second part of the resources used for transmission of the UL message. The first and second part of the UL message may for example correspond to different parts of a bitstream of the UL message. The first and second resources may for example correspond to different frequency resources and/or different time resources.

At step 1120, the WD decodes the first UL control data and the second UL control data from the UL message. The decoding of step 1120 may be based on the association of the first UL control data to the first other WD and the association of the second UL control data to the second other WD as optionally indicated by the UL message.

At step 1130, the node controls wireless communication of the first other WD based on the first UL control data. This may for example involve scheduling one or more wireless transmissions by the first other WD, adjusting transmit power of the first other WD, or performing some other link adaptation operation for the first other WD.

At step 1140, the node controls wireless communication of the second other WD based on the second UL control data. This may for example involve scheduling one or more wireless transmissions by the second other WD, adjusting transmit power of the second other WD, or performing some other link adaptation operation for the second other WD.

In some scenarios, the node may also send a DL message to the WD. The DL message may include first DL control data for the first other WD. Alternatively or in addition, the node may also send a DL message to the WD which includes second DL control data for the second other WD. In some cases, the node may send the first DL control data and the second DL control data in the same DL message.

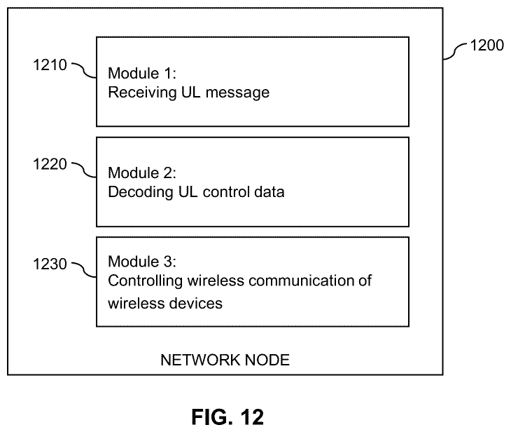

FIG. 12 shows a block diagram for illustrating functionalities of a network node 1200 which operates according to the method of FIG. 11. The network node 1200 may for example correspond to an access node, e.g., one of the above-mentioned access nodes 100, 101. As illustrated, the network node 1200 may be provided with a module 1210 configured to receive a UL message from a WD, such as explained in connection with step 1110. Further, the network node 1200 may be provided with a module 1220 configured to decode first and second UL control data from the UL message, such as explained in connection with step 1120. Further, the network node 1200 may be provided with a module 1230 configured to control wireless communication of a first other WD based on the first UL control data, such as explained in connection with step 1130. Further, the network node 1200 may be provided with a module 1240 configured to control wireless communication of a second other WD based on the second UL control data, such as explained in connection with step 1140.

It is noted that the network node 1200 may include further modules for implementing other functionalities, such as known functionalities of an eNB in the LTE technology or of a gNB in the NR technology. Further, it is noted that the modules of the network node 1200 do not necessarily represent a hardware structure of the network node 1200, but may also correspond to functional elements, e.g., implemented by hardware, software, or a combination thereof.

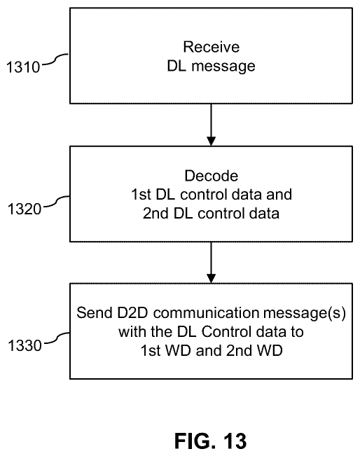

FIG. 13 shows a flowchart for illustrating a method, which may be utilized for implementing the illustrated concepts. The method of FIG. 13 may be used for implementing the illustrated concepts in a WD operating in a wireless communication network. For example, the WD may correspond to any of the above-mentioned UEs 10, 11, 12. In the method of FIG. 13, the WD acts as a relay UE.

If a processor-based implementation of the WD is used, at least some of the steps of the method of FIG. 13 may be performed and/or controlled by one or more processors of the WD. Such WD may also include a memory storing program code for implementing at least some of the below described functionalities or steps of the method of FIG. 13.

At step 1310, the WD receives a DL message from a node of the wireless communication network. The DL message includes first DL control data for a first other WD and second DL control data for a second other WD. The first other WD may correspond to a UE, e.g., one of the above-mentioned UEs 10, 11, 12, 13. In particular, the first other WD may be a remote UE, such as the above-mentioned UE 12 or 13. Also the second other WD may correspond to a UE, e.g., one of the above-mentioned UEs 10, 11, 12, 13. In particular, the second other WD may be a remote UE, such as the above-mentioned UE 12 or 13. In some scenarios, the UL message further includes user plane data from the WD device and/or UL control data from the WD. In some cases, the DL message may further include user plane data for the WD and/or DL control data for the WD.

The first DL control data may include first physical layer DCI for the first other WD. The first physical layer DCI may include a resource assignment for a UL transmission from the first other WD, a resource assignment for a DL transmission to the first other WD, and/or a resource assignment for D2D communication by the first other WD. In addition or as an alternative, the first physical layer DCI may include an acknowledgement for UL data transmitted from the first other WD to the node, e.g., HARQ feedback. The second DL control data may include second physical layer DCI for the second other WD. The second physical layer DCI may include a resource assignment for a UL transmission from the second other WD, a resource assignment for a DL transmission to the second other WD, and/or a resource assignment for D2D communication by the second other WD. In addition or as an alternative, the second physical layer DCI may include an acknowledgement for UL data transmitted from the second other WD to the node, e.g., HARQ feedback. In addition or as an alternative, the first DL control data may include at least one first MAC-CE for the first other WD, e.g., a MAC-CE with a DRX command. The second DL control data may include at least one second MAC-CE for the second other WD, e.g., a MAC-CE with a DRX command.

The DL message may indicate an association of the first DL control data to the first other WD and an association of the second DL control data to the second other WD. This association may be indicated by at least one of: the DL message including an identifier of the first other WD, the DL message including an identifier of the second other WD, the DL message including a group identifier of a group of WDs comprising at least the first other WD and the second other WD, a configured bit mapping which maps the first other WD to a first part of the DL message and maps the second other wireless device to a second part of the DL message, and a configured resource mapping which maps the first other WD to a first part of resources used for transmission of the DL message and maps the second other WD to a second part of the resources used for transmission of the DL message. The first and second part of the DL message may for example correspond to different parts of a bitstream of the DL message. The first and second resources may for example correspond to different frequency resources and/or different time resources.

At step 1320, the WD decodes the first DL control data and the second DL control data from the DL message. The decoding of step 1320 may be based on the association of the first DL control data to the first other WD and the association of the second DL control data to the second other WD as optionally indicated by the DL message.

At step 1330, the WD sends one or more D2D communication messages to the first other WD and the second other WD. The one or more D2D communication messages include the first DL control data and the second DL control data. The one or more D2D communication messages may include a first D2D communication message to the first other WD and a second D2D communication message to the second other WD. Alternatively or in addition, the one or more D2D communication messages may include a D2D communication message to a group of WDs including at least the first other WD and the second other WD, e.g., a broadcast or multicast D2D communication message.

In some scenarios, the WD may further receive a first D2D communication message from the first other WD, and decode first UL control data from the received first D2D communication message. The first UL control data originate from the first other WD. The first UL control data may include first physical layer UCI from the first other WD. The first physical layer UCI may include a SR from the first other WD, CSI from the first other WD, and/or an acknowledgement for DL data transmitted to the first other WD, e.g., HARQ feedback. Alternatively or in addition, the first UL control data may include at least one first MAC-CE from the first other WD. The at least one first MAC-CE may include a BSR and/or a PHR. The WD may then send a UL message including the first UL control data to the node. Alternatively or in addition, the WD may further receive a second D2D communication message from the second other WD, and decode second UL control data from the received second D2D communication message. The second UL control data originate from the second other WD. The second UL control data may include second physical layer UCI from the second other WD. The second physical layer UCI may include a SR from the second other WD, CSI from the second other WD, and/or an acknowledgement for DL data transmitted to the second other WD, e.g., HARQ feedback. Alternatively or in addition, the second UL control data may include at least one second MAC-CE from the second other WD. The at least one second MAC-CE may include a BSR and/or a PHR. The WD may then send a UL message including the second UL control data to the node. In some scenarios, the WD may send the first UL control data and the second UL control data in the same UL message to the node.

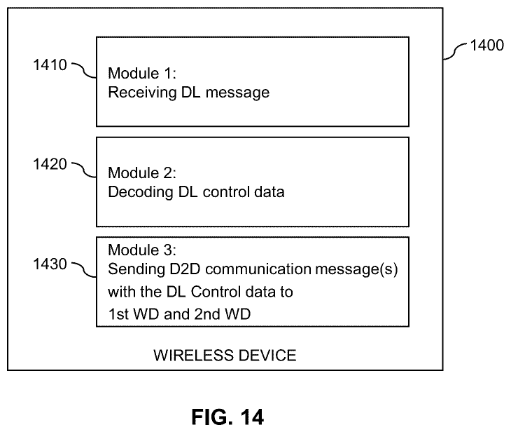

FIG. 14 shows a block diagram for illustrating functionalities of a WD 1400 for a wireless communication network which operates according to the method of FIG. 13. The WD 1400 may for example correspond to above-mentioned UEs 10, 11, 12, 13. As illustrated, the WD 1400 may be provided with a module 1410 configured to receive a DL messages including first and second DL control data, such as explained in connection with step 1310. Further, the WD 1400 may be provided with a module 1420 configured to decode the first and second DL control data from the DL message, such as explained in connection with step 1320. Further, the WD 1400 may be provided with a module 1430 configured to send a D2D communication messages with the first and second DL control data, such as explained in connection with step 1330.

It is noted that the WD 1400 may include further modules for implementing other functionalities, such as known functionalities of a UE in the LTE or NR technology. Further, it is noted that the modules of the WD 1400 do not necessarily represent a hardware structure of the WD 1400, but may also correspond to functional elements, e.g., implemented by hardware, software, or a combination thereof.

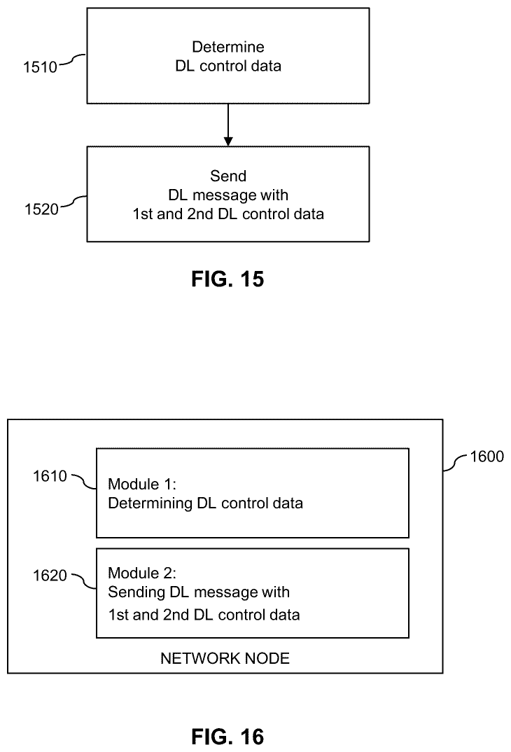

FIG. 15 shows a flowchart for illustrating a method, which may be utilized for implementing the illustrated concepts. The method of FIG. 15 may be used for implementing the illustrated concepts in a node of a wireless communication network. For example, the node may correspond to an access node, such as one of the above-mentioned access nodes 100, 101.

If a processor-based implementation of the node is used, at least some of the steps of the method of FIG. 15 may be performed and/or controlled by one or more processors of the node. Such node may also include a memory storing program code for implementing at least some of the below described functionalities or steps of the method of FIG. 15.

At step 1510, the node may determine DL control data for at least one of a WD, a first other WD, and a second other WD. The WD has D2D connectivity to the first other WD and the second other WD. The WD may be a UE, e.g., one of the above-mentioned UEs 10, 11, 12, 13. In particular, the WD may be a relay UE, such as the above-mentioned UE 11. In some scenarios, the node may determine the DL control data based on UL control data from at least one of the WD, the first WD, and the second WD, e.g., in a scheduling process, in a transmit power control process, or in a link adaptation process.

At step 1520, the node sends a DL message to the WD. The DL message includes first DL control data for the first other WD and second DL control data for the second other WD. The first DL control data controls wireless communication of the first other WD and the second DL control data controls wireless communication of the second other DL. For example, the first and second DL control data may be determined at step 1510.

The first DL control data may include first physical layer DCI for the first other WD. The first physical layer DCI may include a resource assignment for a UL transmission from the first other WD, a resource assignment for a DL transmission to the first other WD, and/or a resource assignment for D2D communication by the first other WD. Alternatively or in addition, the first physical layer DCI may include an acknowledgement for UL data transmitted from the first other WD to the node, e.g., HARQ feedback. The second DL control data may include second physical layer DCI for the second other WD. The second physical layer DCI may include a resource assignment for a UL transmission from the second other WD, a resource assignment for a DL transmission to the second other WD, and/or a resource assignment for D2D communication by the second other WD. Alternatively or in addition, the second physical layer DCI may include an acknowledgement for UL data transmitted from the second other WD to the node, e.g., HARQ feedback. In addition or as an alternative, the first DL control data may include at least one first MAC-CE for the first other WD, e.g., a MAC-CE with a DRX command. The second DL control data may include at least one second MAC-CE for the second other WD, e.g., a MAC-CE with a DRX command.

The DL message may indicate an association of the first DL control data to the first other WD and an association of the second DL control data to the second other WD. This association may be indicated by at least one of: the DL message including an identifier of the first other WD, the DL message including an identifier of the second other WD, the DL message including a group identifier of a group of WDs comprising at least the first other WD and the second other WD, a configured bit mapping which maps the first other WD to a first part of the DL message and maps the second other wireless device to a second part of the DL message, and a configured resource mapping which maps the first other WD to a first part of resources used for transmission of the DL message and maps the second other WD to a second part of the resources used for transmission of the DL message. The first and second part of the DL message may for example correspond to different parts of a bitstream of the DL message. The first and second resources may for example correspond to different frequency resources and/or different time resources.

FIG. 16 shows a block diagram for illustrating functionalities of a network node 1600 which operates according to the method of FIG. 15. The network node 1600 may for example correspond to an access node, e.g., one of the above-mentioned access nodes 100, 101. As illustrated, the network node 1600 may be provided with a module 1610 configured to determine DL control data, such as explained in connection with step 1510. Further, the network node 1600 may be provided with a module 1620 configured to send a DL message including first DL control data and second DL control data, such as explained in connection with step 1520.

It is noted that the network node 1600 may include further modules for implementing other functionalities, such as known functionalities of an eNB in the LTE technology or of a gNB in the NR technology. Further, it is noted that the modules of the network node 1600 do not necessarily represent a hardware structure of the network node 1600, but may also correspond to functional elements, e.g., implemented by hardware, software, or a combination thereof.

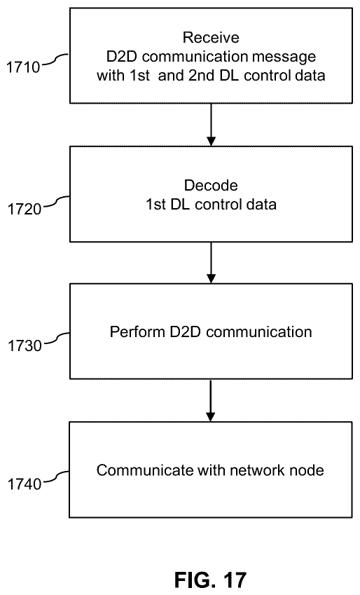

FIG. 17 shows a flowchart for illustrating a method, which may be utilized for implementing the illustrated concepts. The method of FIG. 17 may be used for implementing the illustrated concepts in a WD operating in a wireless communication network. For example, the WD may correspond to any of the above-mentioned UEs 10, 11, 12. In the method of FIG. 13, the WD acts as a remote UE.

If a processor-based implementation of the WD is used, at least some of the steps of the method of FIG. 17 may be performed and/or controlled by one or more processors of the WD. Such WD may also include a memory storing program code for implementing at least some of the below described functionalities or steps of the method of FIG. 17.

At step 1710, the WD receives a D2D communication message from a first other WD. The first other WD may correspond to any of the above-mentioned UEs 10, 11, 12, in particular to a relay UE, such as the above-mentioned UE 11. The D2D communication message includes first DL control data for the WD and second DL control data for a second other WD. The second other WD may correspond to any of the above-mentioned UEs 10, 11, 12, in particular to another remote UE, such as the above-mentioned UEs 12, 13. The first DL control data may be specific to the wireless device. The second DL control data may be associated with group of WDs which includes the WD and the second WD.

The first DL control data may include first physical layer DCI for the WD. The first physical layer DCI may include a resource assignment for a UL transmission from the WD, a resource assignment for a DL transmission to the WD, and/or a resource assignment for D2D communication by the WD. Alternatively or in addition, the first physical layer DCI may include an acknowledgement for UL data transmitted from the WD to the node, e.g., HARQ feedback. The second DL control data may include common physical layer DCI for the WD and the second other WD. The second DL control data may include second physical layer DCI for the second other WD. The second physical layer DCI may include a resource assignment for a UL transmission from the second other WD, a resource assignment for a DL transmission to the second other WD, and/or a resource assignment for D2D communication by the second other WD. Alternatively or in addition, the second physical layer DCI may include an acknowledgement for UL data transmitted from the second other WD to the node, e.g., HARQ feedback. In addition or as an alternative, the first DL control data may include at least one first MAC-CE for the WD, e.g., a MAC-CE with a DRX command. The second DL control data may include at least one common MAC-CE for the WD and the second other WD. The second DL control data may include at least one second MAC-CE for the second other WD, e.g., a MAC-CE with a DRX command.

At step 1720, the WD decodes at least the first DL control data from the D2D communication message. In some cases, the WD may also decode the second DL control data from the D2D communication message.

At step 1730, the WD performs D2D communication based on the first DL control data. If the second DL control data is associated with group of WDs which includes the WD and the second WD, the WD may perform the D2D communication further based on the second DL control data.

At step 1740, the WD communicates with a node of the wireless communication network based on the first DL control data. Here, it is noted that step 1740 may be performed in addition or as an alternative to step 130. If the second DL control data is associated with group of WDs which includes the WD and the second WD, the WD may perform the communication with the node further based on the second DL control data.

In some scenarios, the WD may also send a further D2D communication message to the first other WD. The further D2D communication message may include UL control data from the WD. The UL control data may include physical layer UCI from the WD. The physical layer UCI may include a SR from the WD, CSI from the WD, and/or an acknowledgement for DL data transmitted to the WD, e.g., HARQ feedback. Alternatively or in addition, the UL control data may include at least one MAC-CE from the WD. The at least one MAC-CE may include a BSR, and/or a PHR.

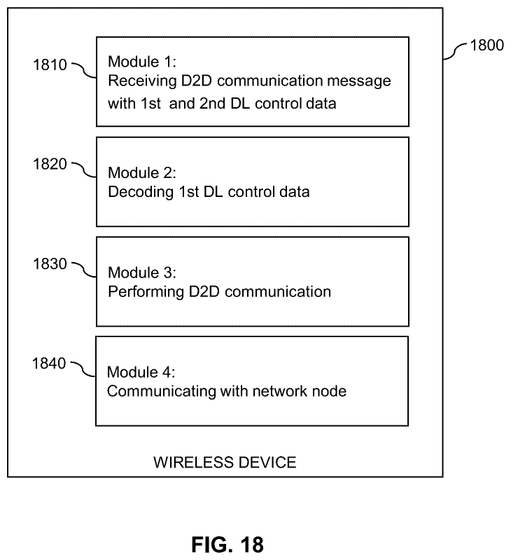

FIG. 18 shows a block diagram for illustrating functionalities of a WD 1800 for a wireless communication network which operates according to the method of FIG. 17. The WD 1800 may for example correspond to above-mentioned UEs 10, 11, 12, 13. As illustrated, the WD 1800 may be provided with a module 1810 configured to receive a D2D communication message including first and second DL control data, such as explained in connection with step 1710. Further, the WD 1800 may be provided with a module 1820 configured to decode at least the first DL control data from the D2D communication message, such as explained in connection with step 1720. Further, the WD 1800 may be provided with a module 1830 configured to perform D2D communication, such as explained in connection with step 1730. Further, the WD 1800 may be provided with a module 1840 configured to communicate with a network node, such as explained in connection with step 1740.

It is noted that the WD 1800 may include further modules for implementing other functionalities, such as known functionalities of a UE in the LTE or NR technology. Further, it is noted that the modules of the WD 1800 do not necessarily represent a hardware structure of the WD 1800, but may also correspond to functional elements, e.g., implemented by hardware, software, or a combination thereof.

It is noted that at least some of the methods of FIGS. 9, 11, 13, 15, and 17 may also be combined in a system which includes a group of WDs, of which at least one operates according to the method of FIG. 9 and/or according to the method of FIG. 13 and an access node that operates according to the method of FIG. 11 and or according to the method of FIG. 15. Further, the group of UEs could include at least one WD operating according to the method of FIG. 17.

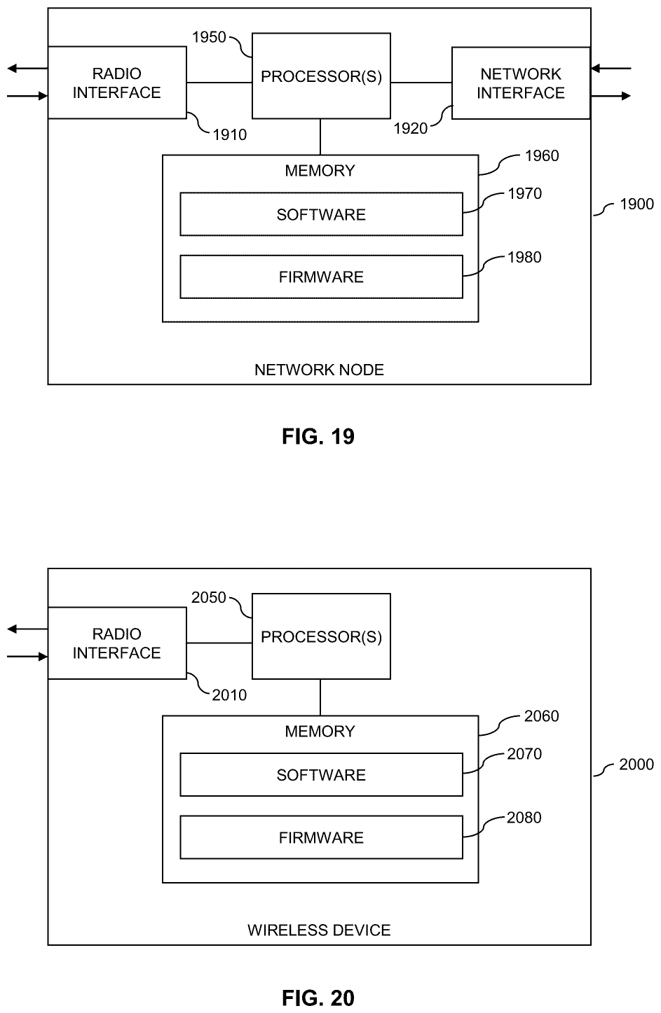

FIG. 19 illustrates a processor-based implementation of a node 1900 for a wireless communication network, which may be used for implementing the above-described concepts. For example, the structures as illustrated in FIG. 19 may be used for implementing the concepts in the access node 100 or 101. The node 1900 may for example implement an eNB of the LTE technology or a gNB of the NR technology.

As illustrated, the node 1900 may include one or more radio interfaces 1910. The radio interface(s) 1910 may for example be based on the NR technology or the LTE technology. The radio interface(s) 1910 may be used for connecting to WDs, such as any of the above-mentioned UEs 10, 11, 12, 13. Further, the node 1900 may include one or more network interfaces 1920. The network interface(s) 1920 may for example be used for communication with one or more other nodes of the wireless communication network, e.g., access nodes or CN nodes.

Further, the node 1900 may include one or more processors 1950 coupled to the interface(s) 1910, 1920 and a memory 1960 coupled to the processor(s) 1950. By way of example, the interface(s) 1910, 1920, the processor(s) 1950, and the memory 1960 could be coupled by one or more internal bus systems of the node 1900. The memory 1960 may include a read-only memory (ROM), e.g., a flash ROM, a random-access memory (RAM), e.g., a dynamic RAM (DRAM) or static RAM (SRAM), a mass storage, e.g., a hard disk or solid state disk, or the like. As illustrated, the memory 1960 may include software 1970 and/or firmware 1980. The memory 1960 may include suitably configured program code to be executed by the processor(s) 1950 so as to implement or configure the above-described functionalities for controlling wireless communication based on UL control data and/or DL control data, such as explained in connection with FIG. 11 or 15.

It is to be understood that the structures as illustrated in FIG. 19 are merely schematic and that the access node 1900 may actually include further components which, for the sake of clarity, have not been illustrated, e.g., further interfaces or further processors. Also, it is to be understood that the memory 1960 may include further program code for implementing known functionalities of a gNB in the NR technology or an eNB in the LTE technology. According to some embodiments, also a computer program may be provided for implementing functionalities of the access node 1900, e.g., in the form of a physical medium storing the program code and/or other data to be stored in the memory 1960 or by making the program code available for download or by streaming.

FIG. 20 illustrates a processor-based implementation of a wireless device 2000 which may be used for implementing the above-described concepts. For example, the structures as illustrated in FIG. 20 may be used for implementing the concepts in any of the above-mentioned UEs 10, 11, 12, 13.

As illustrated, the wireless device 2000 includes one or more radio interfaces 2010. The radio interface(s) 2010 may for example be based on the NR technology or the LTE technology. The radio interface(s) 2010 may be used for providing connectivity of the wireless device to a wireless communication network, e.g., via one or more access nodes of the wireless communication network, such as the above-mentioned access nodes 100 or 101.

Further, the wireless device 2000 may include one or more processors 2050 coupled to the radio interface(s) 2010 and a memory 2060 coupled to the processor(s) 2050. By way of example, the radio interface(s) 2010, the processor(s) 2050, and the memory 2060 could be coupled by one or more internal bus systems of the wireless device 2000. The memory 2060 may include a ROM, e.g., a flash ROM, a RAM, e.g., a DRAM or SRAM, a mass storage, e.g., a hard disk or solid state disk, or the like. As illustrated, the memory 2060 may include software 2070 and/or firmware 2080. The memory 2060 may include suitably configured program code to be executed by the processor(s) 2050 so as to implement the above-described functionalities for controlling wireless communication based on UL control data and/or DL control data, such as explained in connection with FIG. 9, 13, or 17.

It is to be understood that the structures as illustrated in FIG. 20 are merely schematic and that the wireless device 2000 may actually include further components which, for the sake of clarity, have not been illustrated, e.g., further interfaces, such as a dedicated management interface, or further processors. Also, it is to be understood that the memory 2060 may include further program code for implementing known functionalities of a UE. According to some embodiments, also a computer program may be provided for implementing functionalities of the wireless device 2000, e.g., in the form of a physical medium storing the program code and/or other data to be stored in the memory 2060 or by making the program code available for download or by streaming.

As can be seen, the concepts as described above may be used for efficiently controlling wireless communication based on various kinds of UL control data and UL control data, in particular in scenarios where a group of UEs has D2D connectivity to each a UE from the group can act as a relay UE. The UL control data or DL control data can be efficiently conveyed to its destination, even if a remote UE happens to be out of coverage of access nodes of the wireless communication network.

It is to be understood that the examples and embodiments as explained above are merely illustrative and susceptible to various modifications. For example, the illustrated concepts may be applied in connection with various kinds of wireless communication technologies. Further, the concepts may be applied with respect to various types of UEs or WDs. It is also noted in some cases the combined UL control data could also be transmitted to a still further WD, rather than to a network node. Similarly, a still further WD could send the combined DL control data. Further, the illustrated principles could also be applied on other protocol layer above the MAC, e.g., RLC (Radio Link Control), PDCP (Packet Data Convergence Protocol), SDAP (Service Data Adaptation Protocol), or RRC.

Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1. A method of controlling communication in a wireless communication network, the method comprising:
a wireless device receiving a first device-to-device, D2D, communication message from a first other wireless device and a second D2D communication message from a second other wireless device;
from the first D2D communication message, the wireless device decoding first uplink control data from the first other wireless device;
from the second D2D communication message, the wireless device decoding second uplink control data from the second other wireless device; and
the wireless device sending an uplink message comprising the first uplink control data and the second uplink control data to a node of the wireless communication network, wherein the uplink message indicates an association of the first uplink control data to the first other wireless device and an association of the second uplink control data to the second other wireless device by a configured bit mapping which maps the first other wireless device to a first part of the uplink message and maps the second other wireless device to a second part of the uplink message.

2. The method according to claim 1,
wherein the uplink message further comprises user plane data from the wireless device or uplink control data from the wireless device.

3. The method according to claim 1,
wherein the uplink message indicates an association of the first uplink control data to the first other wireless device and an association of the second uplink control data to the second other wireless device by at least one of:
comprising an identifier of the first other wireless device,
comprising an identifier of the second other wireless device,
comprising a group identifier of a group of wireless devices comprising at least the first other wireless device and the second other wireless device, and
a configured resource mapping which maps the first other wireless device to a first part of resources used for transmission of the uplink message and maps the second other wireless device to a second part of the resources used for transmission of the uplink message.

4. The method according to claim 1,
wherein the first uplink control data comprise first physical layer Uplink Control Information, UCI, from the first other wireless device.

5. The method according to claim 4,
wherein the first physical layer UCI comprises a scheduling request from the first other wireless device or channel state information, CSI, from the first other wireless device, or an acknowledgement for downlink data transmitted from the node to the first other wireless device.

6. The method according to claim 1,
wherein the second uplink control data comprise second physical layer UCI from the second other wireless device.

7. The method according to claim 6,
wherein the second physical layer UCI comprises a scheduling request from the second other wireless device, CSI from the second other wireless device, or an acknowledgement for downlink data transmitted from the node to the second other wireless device.

8. The method according to claim 1,
wherein the first uplink control data comprise at least one first Medium Access Control Element, MAC-CE, from the first other wireless device.

9. The method according to claim 8,
wherein the at least one first MAC-CE comprises a buffer status report or a power headroom report.

10. The method according to claim 1,
wherein the second uplink control data comprise at least one second MAC-CE from the second other wireless device.

11. The method according to claim 10,
wherein the at least one second MAC-CE comprises a buffer status report or a power headroom report.

12. The method according to claim 1, comprising:
the wireless device receiving a downlink message from the node, the downlink message comprising first downlink control data for the first other wireless device;
from the downlink message, the wireless device decoding the first downlink control data; and
the wireless device sending a D2D communication message to the first other wireless device, the D2D communication message comprising the first downlink control data.

13. The method according to claim 1, comprising:
the wireless device receiving a downlink message from the node, the downlink message comprising second downlink control data for the second other wireless device;
from the one or more downlink messages, the wireless device decoding the second downlink control data; and
the wireless device sending a D2D communication message to the second other wireless device, the D2D communication message comprising the second downlink control data.

14. The method according to claim 13,
wherein the wireless device decodes the first downlink control data and the second downlink control data from the same downlink message.

15. A method of controlling communication in a wireless communication network, the method comprising:
a node of the wireless communication network receiving an uplink message from a wireless device, the uplink message comprising first uplink control data from a first other wireless device and second uplink control data from a second other wireless device, wherein the uplink message indicates an association of the first uplink control data to the first other wireless device and an association of the second uplink control data to the second other wireless device by a configured bit mapping which maps the first other wireless device to a first part of the uplink message and maps the second other wireless device to a second part of the uplink message;
from the uplink message, the node decoding the first uplink control data and the second uplink control data;
based on the first uplink control data, the node controlling wireless communication of the first other wireless device; and
based on the second uplink control data, the node controlling wireless communication of the second other wireless device.

16. The method according to claim 15,
wherein the uplink message further comprises user plane data from the wireless device or wherein the uplink message further comprises uplink control data from the wireless device.

17. The method according to claim 15,
wherein the uplink message indicates an association of the first uplink control data to the first other wireless device and an association of the second uplink control data to the second other wireless device by at least one of:
comprising an identifier of the first other wireless device,
comprising an identifier of the second other wireless device,
comprising a group identifier of a group of wireless devices comprising at least the first other wireless device and the second other wireless device,
a configured resource mapping which maps the first other wireless device to a first part of resources used for transmission of the uplink message and maps the second other wireless device to a second part of the resources used for transmission of the uplink message.

18-60. (canceled)

61. A wireless device for operation in a wireless communication network, the wireless device being configured to:
receive a first device-to-device, D2D, communication message from a first other wireless device and a second D2D communication message from a second other wireless device;
from the first D2D communication message, decode first uplink control data from the first other wireless device;
from the second D2D communication message, decode second uplink control data from the second other wireless device; and
send an uplink message comprising the first uplink control data and the second uplink control data to a node of the wireless communication network, wherein the uplink message indicates an association of the first uplink control data to the first other wireless device and an association of the second uplink control data to the second other wireless device by a configured bit mapping which maps the first other wireless device to a first part of the uplink message and maps the second other wireless device to a second part of the uplink message.

62-77. (canceled)

78. A non-transitory computer-readable medium comprising program code to be executed by at least one processor of a wireless device, whereby execution of the program code causes the wireless device to perform the method according to claim 1.

79. A non-transitory computer-readable medium comprising program code to be executed by at least one processor of a node for a wireless communication network, whereby execution of the program code causes the node to perform the method according to claim 15.
